(19) United States
(12) Patent Application Publication
(10) Pub. No.: US 2007/0269580 A1
(43) Pub. Date: Nov. 22, 2007

(54) PROCESSES FOR PRODUCING FOOD COMPOSITIONS INCLUDING LEGUME PRODUCTS AND PRODUCTS PRODUCED THEREFROM

(76) Inventor: Charles Werstak, Normal, IL (US)

Correspondence Address: ARCHER DANIELS MIDLAND COMPANY, 4666 FARIES PARKWAY, DECATUR, IL, 62526, US

(21) Appl. No.: 11/750,008

(22) Filed: May 17, 2007

Related U.S. Application Data
(60) Provisional application No. 60/801,892, filed on May 19, 2006.

(51) Int. Cl. A23L 1/20

(52) U.S. Cl. 426/634

(57) ABSTRACT

The present invention relates generally to food compositions, as well as processes for producing and methods of distributing the food compositions. The food compositions of the present invention include legume products.

### CROSS-REFERENCE TO RELATED APPLICATION

This application claims the benefit of U.S. Provisional Application No. 60/801,892, filed May 19, 2006, the contents of the entirety which is incorporated by this reference.

### TECHNICAL FIELD

The present invention relates generally to food compositions, as well as processes for producing and methods of distributing the food compositions.

### BACKGROUND

In the United States, there is an increasing concern over the consumption of high fat foods by the population. One place where consumers may find high fat foods is in dips or sauces. Since these dips or sauces may be made with milk or milk proteins, these food products may also contain high amounts of fat from the milk source in order to thicken the dips or sauces, thus, allowing the dips or sauces to stick to or coat the chip or cracker.

Thus, what is needed is a dip or sauce that is low in fat, yet retains many of the functional properties of conventional dips or sauces.

### SUMMARY OF THE INVENTION

In each of its various embodiments, the present invention helps fulfill these needs and discloses healthier food products and processes for producing them.

In one embodiment, a food composition comprises a legume product and an ingredient selected from the group consisting of a monoglyceride, a soluble fiber, a sweetener, sodium stearoyl lactylate, glucono delta lactone, calcium citrate, and combinations of any thereof.

In another embodiment, a process for producing a food composition includes placing a legume product and at least one dry ingredient in a container, thus producing a dry mix, and adding water to the dry mix and mixing, thus producing a slurry. A compound selected from the group consisting of a fat, an oil, an emulsifier, and any combination thereof is added to the slurry, thus producing the food composition, and the food composition is heated.

In a further embodiment, a food composition comprises whole soybean powder and an ingredient selected from the group consisting of a soluble fiber, starch, a vegetable oil, an emulsifier and any combination thereof. The food composition may be admixed with water such that the whole soybean powder, the ingredient and the water are present in the food composition in such an amount to configure the food composition as a dip.

In yet an additional embodiment, a food composition comprises an edible bean powder and an ingredient selected from the group consisting of a soluble fiber, starch, a vegetable oil, an emulsifier and any combination thereof. The food composition may be admixed with water such that the edible bean powder, the ingredient and the water are present in the food composition in such an amount to configure the food composition as a dip.

In another embodiment, a method of distributing a food composition comprises mixing a legume product with at least one dry ingredient, thus producing a dry mix, placing the dry mix in a container, and shipping the container to a consumer.

In further embodiments, the food compositions of the present invention may be combined with water and configured as dip-like food compositions.

### DETAILED DESCRIPTION OF THE INVENTION

In one embodiment, a food composition of the present invention may be configured a dip and include a legume product such as, for example, a soybean product or an edible bean product. The legume product may be whole soybean powder, whole edible bean powder, isolates thereof, concentrates thereof, or any combinations thereof.

In other embodiments, food products containing legume products, as well as processes for producing and methods of distributing the food products are disclosed. Food compositions having legumes or legume products are typically high in fiber and/or protein as compared to the food compositions not including the legume or legume product. Thus, the incorporation of legumes or legume products into a foodstuff results in a foodstuff having a higher content of fiber and/or protein, while reducing the sugar and/or fat content of the foodstuff.

In one embodiment, a food product or ingredient used in a foodstuff comprises a legume product. The presence of the legume product in the foodstuff enhances or increases the amount of fiber and/or protein in the foodstuff, thus, helping a person consuming the foodstuff to meet their Dietary Guidelines for fiber and/or protein intake. In another embodiment, the distribution of the foodstuff having the enhanced or increased fiber and/or protein to a population may help increase the nutrition of the population and, potentially, help lower incidences of obesity or other diet related diseases.

In one embodiment, the legume from which the legume product originates may be of a Phaseolus species (i.e., beans) or a soy bean. In other embodiments, the legume may comprise green or yellow peas (i.e., Pisum), lentils (i.e., Lens vulgaris), chickpeas (i.e., Cicera arietenum), soybeans (i.e., Glycine max), peanuts, (i.e., Arachis hypogaea), trefoil (i.e., Lotus corniculatus), and combinations of any thereof. In further embodiments, varieties of edible beans that may be used to produce the foodstuffs of the present invention include, without limitation, Pinto beans, Great Northern beans, Navy beans, Red beans, Black beans, dark or light Red Kidney beans, Fava beans, Green Baby Lima beans, Pink beans, MYASI beans, Mayocoba beans, Small Red beans, Black Eyed beans, Garbanzo beans, Cranberry beans, White Beans, Rice beans, Butter beans, African Giraffe beans and any combinations thereof.

In various embodiments, a food product or ingredient produced by the processes of the present invention may take various forms including, but not limited to, a dip, a sauce, a burrito sauce, a taco sauce, a jam, a jelly, a chutney, a salsa, a picante, an enchilada sauce, a taco sauce, a marinade, a condiment, a soup, a stew, a chowder, a pasta sauce, a tomato based sauce, a dairy-like sauce, or a combination of any thereof. Further, the food product or ingredient may be incorporated into a foodstuff in combination with one or more seasonings, spices, a prepared food product, a meat, a meat analogue, or any combination thereof in order to enhance the flavor or nutrition of the foodstuff. In yet other embodiments, processing aids or preservatives may be added to the food product or ingredient in order to affect functionality and shelf life of the foodstuff.

In additional embodiments, the food composition may include other ingredients including, but not limited to: modified or unmodified starches; thickeners such as, for example, pectin, xanthan gum, or microcrystalline cellulose; emulsifiers; fats; buffers; sweeteners; soluble fiber; acids, and any combinations thereof. The fats may be low trans fats including, but not limited to, NOVALIPID brand fats available from Archer Daniels Midland Company of Decatur, Ill. The food composition may also be free from added sugars, and have any desired viscosity achieved by, for example, modifying or blending various quantities of modified starches, unmodified starches, gums, or combinations of any thereof.

In yet other embodiments, the food composition may further include food colorants, vitamins, minerals, edible oils or fats, emulsifiers (e.g., lecithin or a monoglyceride), leavening agents, natural or artificial sweeteners, starches, thickening agents including without limitation a starch or gum (e.g., a xanthan gum), a digestion resistant starch or fiber (including, but not limited to, a soluble fiber (e.g., FIBERSOL brand fiber or INULIN brand fiber) or an insoluble fiber), a cellulose (e.g., microcrystalline cellulose or carboxymethylcellulose), maltodextrins, corn-syrup solids, potato starch, corn starch, wheat starch, a vegetable product, a fruit product, a nut product, a sterol, a lignan extract, an organic acid, water, a soy protein, a soy protein isolate, a soy protein concentrate, a wheat protein, wheat gluten, wheat protein isolate, buttermilk solids, milk powders, egg protein, a canola protein, a pea protein, a potato protein, a corn protein, a sesame protein, a sunflower protein, a cottonseed protein, a copra protein, a palm kernel protein, a safflower protein, a linseed protein, a peanut protein, a lupin protein, a oat protein, oat fiber, a sugar alcohol, a calcium containing compound (e.g., calcium citrate, calcium lactate or calcium carbonate), a texture modifier (e.g., calcium carbonate), a tomato product, or combinations of any thereof may be used. In other embodiments, the food composition may further comprise a flour or a meal. Non-limiting examples of crops that may be used to produce the flour or meal include, but are not limited to, corn, rice, whole wheat, whole grain, barley, durum, sorghum, sunflower, canola, oats, flax, potatoes, buckwheat and combinations of any thereof (e.g., such as a multigrain product).

In one embodiment, the legume product may comprise whole soybean powder such as, for example, finely ground whole, dehulled soybeans. One process for producing whole soybean powder includes heating, cracking and de-hulling whole soybeans. One whole soybean powder that may be used is described in US Patent Application Publication No. 2004/0197463 assigned to Archer Daniels Midland Company, the contents of the entirety which is incorporated by this reference. The soybeans may be heat-treated to inactivate the lipoxygenase enzyme, and milled to produce a fine slurry, which may be pasteurized and homogenized. The whole soybean slurry may be spray-dried to produce a whole soybean powder. Various nutritive benefits are realized by the use of whole soybean powder, which contain large amounts of fiber and beneficial compounds naturally found in the whole soybean cotyledon. One non-limiting example of a whole soybean powder that may be used is NUTRISOY brand whole bean powder available from Archer Daniels Midland Company of Decatur, Ill.

Modifications to the process for producing whole soybean powder, as well as other methods for making whole soybean powder may also be employed in the methods of the present invention. Various parameters of the process may be changed and additional steps may be added. For example, the pasteurization may be conducted in any acceptable manner. Non-limiting examples of pasteurization conditions include, but are not limited to: 30 minutes at 145° F. (i.e., low temperature long time pasteurization); 15 seconds at 161° F. (i.e., high temperature short time pasteurization); and 8 seconds at 240° F. (i.e., Ultra High Temperature (UHT) pasteurization). In aseptic pasteurization, the product is packaged in sterile, sealed containers to maximize shelf life. The act of enzyme inactivation may be conducted under any suitable condition including, but not limited to, at 90° C. for 1 minute. The milling and homogenization processes may also be subject to great variation, depending on the manufacturer and the machines used for each process.

In an additional embodiment, the legume product may be produced by milling an edible bean or edible bean product into a powder. In another embodiment, a dehydrated legume powder or dehydrated legume flour may be used as the legume powder, and be produced by milling a dehydrated legume or dehydrated legume product into a powder. One example of a dehydrated legume product that may be used includes, but is not limited to, a dehydrated edible bean product available from Archer Daniels Midland Company of Decatur, Ill.

In another embodiment, the dehydrated legume or dehydrated legume product may be produced using the process described in US Patent Application 2005/0095346 assigned to Archer Daniels Midland Company of Decatur, Ill., entitled Process for the Production of Reconstitutable Bean Products published May 5, 2005, the contents of the entirety of which is incorporated by this reference. In another embodiment, the process for dehydrating the legume or legume product may include blanching the legume or legume product, cooking the blanched legume or legume product, and/or dehydrating the cooked legume or legume product to form a dehydrated or reconstitutable legume or legume product.

In a further embodiment, a dehydrated legume, a dehydrated legume flour, a dehydrated legume powder or a dehydrated legume product used in the foodstuffs of the present invention has an increased dietary fiber percentage on a weight basis as compared to a non-dehydrated or raw legume, flour, powder or product from which the dehydrated legume, dehydrated legume flour, dehydrated legume powder or dehydrated legume product originates. For example, dehydrated Pinto beans comprise about 27% dietary fiber, while non-dehydrated or raw Pinto beans comprise about 12% dietary fiber; dehydrated Small Red beans comprises about 23% dietary fiber, while non-dehydrated or raw Small Red beans comprise about 8.9% dietary fiber; dehydrated Black beans comprise about 29% dietary fiber, while non-dehydrated or raw Black beans comprise about 13.3% dietary fiber; dehydrated Navy beans comprise about 23% dietary fiber, while non-dehydrated or raw Navy beans comprise about 9.8% dietary fiber; dehydrated Dark Red Kidney beans comprise about 24% dietary fiber, while non-dehydrated or raw Light Red Kidney beans comprise about 10.6% dietary fiber; and dehydrated Light Red Kidney beans comprise about 24% dietary fiber, while non-dehydrated or raw Light Red Kidney beans comprise about 10.6% dietary fiber.

In another embodiment, a dehydrated legume or legume product is subjected to a milling process to produce a dehydrated legume powder. In a further embodiment, the dehydrated legume or legume product is subjected to a form of crushing or pulverizing such as by passage of the dehydrated legume or legume product through a hammer mill or universal mill. In one embodiment, the dehydrated legume or legume product is ground in a PC-20 mill. The ground or powdered dehydrated legume or legume product may be passed through a swecoscreen 60 mesh, wherein the ground or powdered dehydrated legume or legume product has a particle size of less than about 0.250 mm. The ground or powdered dehydrated legume or legume product may further be passed by a magnet to remove any metallic (i.e., iron-containing) contaminants, and further be placed in containers for shipping or placed in a food product.

In further embodiments, the food compositions of the present invention may be used in combination with other foodstuffs including without limitation, a breakfast cereal, snack bar, a snack chip, nutrition bar, breakfast bar, candy, meat substitute, bread or breading substitute, animal food, puffed snack (i.e., puffed curl, puffed ball, or the like), crunchy curl, chip, tortilla chip, extruded curl, corn chip, multigrain chip, any extruded food product, multigrain snack, flat bread, biscuit, crisp bread, protein inclusion, cone, cookie, flaked product, fortune cookie, pasta, rice cake, puffed wheat cake, maize cake, or other known foodstuff.

In yet an additional embodiment, the food compositions of the present invention including any of the disclosed legume products may be produced at a first geographic location and transported or shipped to a second geographic location. For instance, a facility at the first geographic location may be able to produce a product more economically than a facility at the second location due to various factors. The factors may include, inter alia, lower costs of materials (i.e., the legumes themselves, pesticides used for legume production, fertilizers), lower costs of energy (i.e., electricity or gas), lower costs of labor (i.e., wages paid to employees), lower costs of environmental controls or effects (i.e., a drought may be present in one location or certain pesticides may be highly regulated in one location), or any other requirement for production. Further, a certain product may be well suited for production in the first geographic location and desired, but not produced well in the second geographic location. As a non-limiting example, residents of Alaska may desire bananas produced in Central America. Thus, the costs of producing the products in the first geographic location may be less than the costs of producing the products in the second geographic location resulting in the production costs of the product being less in the first geographic location.

In such an instance, the food compositions including any of the disclosed legume products may be produced at the first geographic location and shipped to the second geographic location such as by transport over water with ships or barges, trucking, flying, or other means of transportation. The geographic location may be a county, a state, a country, a continent and/or combinations of any thereof. In this manner, the product may be produced in a first country, and transported and/or sold in a second country.

In another embodiment, at least one of the ingredients of the food compositions of the present invention may be produced by one company, and combined with at least one other ingredient of the food compositions of the present invention produced by the same company. In this manner, a consumer of the food composition may benefit in receiving the expertise of the company that produces the ingredients, as well as a reduced price of the food composition since the production of the two food ingredients by a single eliminates the need for a “middle man,” thus, reducing the handling cost of another business entity being involved in providing one of the ingredients.

The invention is further explained by use of the following illustrative EXAMPLES.

### EXAMPLES

### Example I

In one embodiment, a food composition in the form of a dip was produced with the following ingredients:

| Ingredient | Percent |
|---|---|
| Interesterified soybean and hydrogenated cottonseed oils, | 9.08 (may |
| NOVALIPID 106-050, (NOVALIPID brand oils from Archer- | range from 5–10%) |
| Daniels-Midland Company, Decatur, Illinois.) | |
| Soluble fiber (FIBERSOL-2 brand digestion resistant maltodextrin | 8.76 (may |
| available from Archer-Daniels-Midland Company, Decatur, | range from 5–10%) |
| Illinois., FIBERSOL-2 is a Trademark Matsutani Chemical | |
| Industry Co., Ltd.) | |
| Monoglycerides, PANALITE 90-45K | 0.54 (may |
| | range from |
| | 0.2–1.5%) |
| Monoglycerides, PANALITE 90-130K | 0.54 (may |
| | range from |
| | 0.2–1.5%) |
| Sweetener, sucralose | 0.01 (may |
| | range from |
| | 0.001–0.02%) |
| Sweetener, acesulfame-K | 0.01 (may |
| | range from |
| | 0.001–.02%) |
| Legume product, NUTRISOY brand organic whole soybean | 7.70 (may |
| powder available from Archer Daniels Midland Company of | range from 5–8%) |
| Decatur, Illinois | |
| Thickener, Avicel RC 584 cellulose gel | 0.67 (may |
| | range from |
| | 0.1–0.7%) |
| Thickener, Pectin YM 100 H pectin | 0.21 (may |
| | range from |
| | 0.1–0.3%) |
| Thickener, NOVAXAN 200 xanthan gum (NOVAXAN brand | 0.11 (may |
| xanthan gums are available from Archer-Daniels-Midland | range from |
| Company, Decatur, Illinois) | 0.05–0.2%) |
| Acid salt, sodium citrate | 0.53 (may |
| | range from |
| | 0.2–1.0%) |
| Salt | 0.16 (may |
| | range from |
| | 0.05–0.3%) |
| Starch, AYTEX P Wheat Starch (AYTEX brand starches are | 4.92 (may |
| available from Archer-Daniels-Midland Company, Decatur, | range from |
| Illinois.) | 2.4–10%) |
| Water | 64.41 (may |
| | range from 30–80% |
| Acid, lactic acid | 0.75 (may |
| | range from |
| | 0.3–1.5%) |
| Acid, citric acid | 0.32 (may |
| | range from |
| | 0.1–0.7%) |
| Total | 100.0 |

The process used to produce the dip included mixing the dry ingredients (i.e., the soluble fiber, the monoglyceride PANALITE 90-45K, the sweeteners, the legume product, the thickeners, the starch and the citric acid) except the salt and the sodium citrate, thus producing a dry mix. Water and the dry mix were added to a Groen kettle and allowed to hydrate with a high shear mixer for about 15 minutes, thus producing a slurry. The sodium citrate and salt were added to the slurry and allowed to mix for about 5 minutes. The oil and monoglycerides were placed in a microwave safe container and melted by placement in a microwave for about 3-5 minutes, thus producing a melted oil composition. The slurry was heated to about 130° F., and the melted oil composition was added to the slurry in the Groen kettle, thus producing a dip base. The dip base was heated to about 190° F. in the Groen kettle, removed from the heat and homogenized at 500/2500/3000 (i.e., 500 lbs/2500 lbs, totaling 3000 lbs) which refers to the use of a two stage homogenizer that employs sets of valves (i.e., first and second stages of valves). The two stage homogenizer applies pressure using turn handles and the pressure is shown on the gauges. The second stage is set first (i.e., 500 lbs) and the first stage is set second (i.e., 2500 lbs), and the pressure totals 3000 lbs. The acids were slowly added to the dip base with continuous stirring. The finished dip base was packaged in containers, and allowed to cool for about 24 hours at about 40-42° F.

The finished dip base may be seasoned or flavored with at least one flavoring agent including, but not limited to, a seasoning, condiment, spice, salt, other desired flavoring agent or any combinations thereof, thus resulting in a food product having a desired seasoning profile. Any desired colorant may also be added to the finished dip base in order to produce a dip having any desired color.

A serving size of about 33 grams of the dip base of this embodiment has the following nutritional profile: about 50 calories, about 10 calories from fat, about 1.5 grams total fat, 0 grams of saturated fat, 0 grams of trans fat, 0 milligrams of cholesterol, about 75 milligrams of sodium, about 9 grams of total carbohydrate, about 4 grams of dietary fiber, 0 grams of sugar, and about 1 gram of protein.

### Example II

In one embodiment, a food composition in the form of a dip was produced with the following ingredients:

| Ingredient | Percent |
|---|---|
| Sunflower Oil, NUSUN brand mid-oleic sunflower oil available | 1.07 (may |
| from Archer Daniels Midland Company of Decatur, Illinois | range from |
| (NUSUN is a registered certification of the National Sunflower | 0.4–2.1%) |
| Association) | |
| Soluble fiber (FIBERSOL-2 brand digestion resistant maltodextrin | 8.03 (may |
| available from Archer-Daniels-Midland Company, Decatur, Illinois, | range from |
| FIBERSOL-2 is a Trademark Matsutani Chemical Industry Co., | 3.5–15%) |
| Ltd.) | |
| Salt | 0.26 (may |
| | range from |
| | 0.1–0.4%) |
| Acid, lactic acid | 0.4 (may |
| | range from |
| | 0.2–0.8%) |
| an acidifier, glucono delta lactone | 0.6 (may |
| | range from |
| | 0.3–1.2%) |
| Emulsifier, PANIPLEX SK brand sodium stearoyl lactylate | 0.2 (may |
| | range from |
| | 0.1–0.5%) |
| Calcium citrate | 0.5 (may |
| | range from |
| | 0.2–1.0%) |
| Monoglycerides, PANALITE 90-03 | 0.8 (may |
| | range from |
| | 0.4–1.6%) |
| Water | 73.7 (may |
| | range from |
| | 35–90%) |
| Legume product, Great Northern bean powder available from | 3.0 (may |
| Archer Daniels Midland Company of Decatur, Illinois) | range from 1–7%) |
| Dried buttermilk | 3.0 (may |
| | range from 1–7%) |
| Thickener, NOVAXAN 200 xanthan gum (NOVAXAN brand | 0.02 (may |
| xanthan gums are available from Archer-Daniels-Midland | range from |
| Company, Decatur, Illinois) | 0.01–0.2%) |
| Acid salt, sodium citrate | 0.3 (may |
| | range from |
| | 0.1–0.6%) |
| Starch (i.e., structure), National Starch Struct-Sure 20 modified | 6.62 (may |
| food starch | range from 2–13%) |
| Soy teeter (shortening, flakes, part hydrogenated soybean oil, | 1.20 (may |
| hard | range from |
| | 0.5–3%) |
| Thickener, Seagel 713 brand carrageenan | 0.3 (may |
| | range from |
| | 0.1–0.6%) |
| Total | 100 |

The process used to produce the dip included mixing the dry ingredients (i.e., the soluble fiber, the salt, the acidifier, the emulsifier, the calcium citrate, the monoglycerides, the legume product, the dried buttermilk, the thickeners (i.e., xanthan gum and carrageenan), the acid salt, the starch, and the teeter) in a plastic bag and dry blending the dry ingredients, thus producing a dry mix. Water and the dry mix were added to a Groen kettle and allowed to hydrate with a high shear mixer for about 15 minutes, thus producing a slurry. The oil and monoglycerides were placed in a microwave safe container and melted by placement in a microwave for about 2 minutes, thus producing a melted oil composition. The slurry was heated to about 130° F., and the melted oil composition was added to the slurry in the Groen kettle, thus producing a dip base. The dip base was heated to about 190° F. with mixing in the Groen kettle, removed from the heat and homogenized at 500/2500/3000(i.e., 500 lbs/2500 lbs, totaling 3000 lbs) which refers to the use of a two stage homogenizer that employs sets of valves (i.e., first and second stages of valves). The two stage homogenizer applies pressure using turn handles and the pressure is shown on the gauges. The second stage is set first (i.e., 500 lbs) and the first stage is set second (i.e., 2500 lbs), and the pressure totals 3000 lbs. The acids were slowly added to the dip base with continuous stirring over at least about a three minute time frame. The finished dip base was packaged in containers, and allowed to cool for about 24 hours at about 40-42° F.

The finished dip base may be seasoned or flavored with at least one flavoring agent including, but not limited to, a seasoning, condiment, spice, salt, other desired flavoring agent or any combinations thereof, thus resulting in a food product having a desired seasoning profile. Any desired colorant may also be added to the finished dip base in order to produce a dip having a desired color.

### Example Ill

In one embodiment, a food composition in the form of a dip was produced with the following ingredients:

| Ingredient | Percent |
|---|---|
| Dewaxed Mild Oleic sunflower oil (NU-SUN brand oil from | 0.99% (may |
| Archer-Daniels-Midland Company, Decatur, Illinois). | range from 0.4–2.1%) |
| Soluble fiber (FIBERSOL-2 brand digestion resistant | 7.45% (may |
| maltodextrin available from Archer-Daniels-Midland | range from 3.5–15%) |
| Company, Decatur, Illinois, FIBERSOL-2 is a Trademark | |
| Matsutani Chemical Industry Co., Ltd.) | |
| Salt | 0.24% (may |
| | range from 0.1–0.4%) |
| Emulsifier, PANIPLEX SK brand sodium stearoyl lactylate | 0.19% (may |
| | range from 0.1–0.5%) |
| Calcium Citrate | 0.46% (may |
| | range from 0.2–1.0%) |
| Monoglycerides, PANALITE 90-03 | 0.74% (may |
| | range from |
| | 0.4%–1.6%) |
| Water | 68.36% (may |
| | range from 35–90%) |
| Legume product, Great Northern bean powder available from | 2.78% (may |
| Archer Daniels Midland Company of Decatur, Illinois) | range from 1–7%) |
| Raspberry Puree, Sensient 240425, available from Sensient | 7.68% (may |
| Technologies Milwaukee, WI | range from 1–15%) |
| Non fat dry milk | 3.02% (may |
| | range from 1–7%) |
| Thickener, NOVAXAN 200 xanthan gum (NOVAXAN brand | 0.02% (may |
| xanthan gums are available from Archer-Daniels-Midland Company, | range from 0.01–02%) |
| Decatur, Illinois) | |
| Acid salt, Sodium Citrate | 0.28% (may |
| | range from 0.1–0.6%) |
| Starch (i.e., structure), National Starch Struct-Sure 20 | 6.14% (may |
| modified food starch | range from 2–13%) |
| Soy teeter (shortening, flakes, part hydrogenated soybean | 1.11% (may |
| oil, hard | range from 0.5–3%) |
| Thickener, Avicel RC 591-F microcrystalline cellulose and | 0.28% (may |
| carboxymethycellulose sodium gel | range from 0.1–0.7%) |
| Acid, Malic Acid | 0.12% may |
| | range from 0.1–0.7% |
| Acid, Citric Acid | 0.14% may |
| | range from 0.1–0.7% |
| Total | 100.00% |

The process used to produce the dip included mixing the dry ingredients (i.e., the soluble fiber, the legume product, the thickeners, the starch and the acid salt) except the emulsifier and monoglycerides, thus producing a dry mix. Water and the dry mix were added to a Groen kettle and allowed to hydrate with a high shear mixer for about 15 minutes, thus producing a slurry. The sodium citrate and salt were added to the slurry and allowed to mix for about 5 minutes.

The oil and monoglycerides were placed in a microwave safe container and melted by placement in a microwave for about 3-5 minutes, thus producing a melted oil composition. The slurry was heated to about 130° F., and the melted oil composition was added to the slurry in the Groen kettle, thus producing a dip base. The dip base was heated to about 190° F. for about 10 minutes in the Groen kettle, removed from the heat and adjusted to pH 3.5 using citric and maleic acids. The dip base was homogenized at 500/2500/3000 (i.e., 500 lbs/2500 lbs, totaling 3000 lbs) which refers to the use of a two stage homogenizer that employs sets of valves (i.e., first and second stages of valves). The two stage homogenizer applies pressure using turn handles and the pressure is shown on the gauges. The second stage is set first (i.e., 500 lbs) and the first stage is set second (i.e., 2500 lbs), and the pressure totals 3000 lbs. The finished dip base was packaged in containers, and allowed to cool for about 24 hours at about 40-42° F.

A serving size of about 33 grams of the dip base of this embodiment has the following nutritional profile: about 35 calories, about 10 calories from fat, about 1 gram total fat, 0.5 grams of saturated fat, 0 grams of trans fat, 0 milligrams of cholesterol, about 65 milligrams of sodium, about 6 grams of total carbohydrate, about 3 grams of dietary fiber, about 1 gram of sugar, and about 1 gram of protein.

The finished dip base may be seasoned or flavored with at least one flavoring agent including, but not limited to, a seasoning, condiment, spice, salt, other desired flavoring agent or any combinations thereof, thus resulting in a food product having a desired seasoning profile. Any desired colorant may also be added to the finished dip base in order to produce a dip having any desired color.

### Example IV

In another embodiment, the dry ingredients of the dip base may be mixed together to form a dry mixture and placed into a container. Further, the wet ingredients (optionally excluding the water) may be admixed together to form a wet mixture and placed into another container. The dry ingredients or the wet ingredients in the containers may be transported or shipped to another location where the dry and wet ingredients may be admixed together, optionally with a flavoring agent and/or colorant, to product a final dip. In this manner, the various ingredients of the dip base (i.e., the dry ingredients, the wet ingredients or the dry and wet ingredients) may be shipped without the water such that a consumer of the ingredients of the dip base does not have to pay to ship the water. In another embodiment, the dry ingredients themselves may be shipped and combined with oils, fats, emulsifiers, water, flavoring agents, colorants, or any combinations thereof at another location.

The dry ingredients, the wet ingredients, or the dry ingredients and the wet ingredients may be further associated with indicia configured to direct a consumer of the ingredients on how to admix the various ingredients together to form the food composition.

The present invention has been described with reference to certain exemplary embodiments, legume products, compositions and uses thereof. However, it will be recognized by those of ordinary skill in the art that various substitutions, modifications or combinations of any of the exemplary embodiments may be made without departing from the spirit and scope of the invention. For instance, although certain ranges of ingredients have been disclosed in the exemplary embodiments, one of ordinary skill in the art will realize that the ranges may be different for various food compositions produced using the ingredients and processes described herein. Thus, the invention is not limited by the description of the exemplary embodiment, but rather by the appended claims as originally filed.

1. A food composition comprising:
a legume product; and
an ingredient selected from the group consisting of a monoglyceride, a soluble fiber, a sweetener, sodium stearoyl lactylate, glucono delta lactone, calcium citrate, and combinations of any thereof.

2. The food composition of claim 1, wherein the legume product is selected from the group consisting of whole soybean powder, an edible bean powder, and combinations thereof.

3. The food composition of claim 1, further comprising a compound selected from the group consisting of an interesterified soybean oil, a hydrogenated cottonseed oil, a sunflower oil, a cellulose gel, pectin, xanthan gum, sodium citrate, salt, starch, lactic acid, citric acid, dried buttermilk, non-fat dry milk, carrageenan, and combinations of any thereof.

4. The food composition of claim 1, further comprising a compound selected from the group consisting of a flavoring agent, a seasoning, a condiment, and combinations of any thereof.

5. The food composition of claim 1, wherein 33 grams of the food composition has no more than 60 calories.

6. The food composition of claim 1, wherein 33 grams of the food composition has at least 2.5 grams of dietary fiber.

7. The food composition of claim 1, further comprising an ingredient selected from the group consisting of a food colorant, vitamin, mineral, edible oil or fat, emulsifier, leavening agent, a natural or artificial sweetener, a thickening agent, a starch, a gum, a digestion resistant starch, a fiber, a cellulose, a maltodextrin, corn-syrup solids, a vegetable product, a fruit product, a nut product, a sterol, a lignan extract, an organic acid, a soy protein, a soy protein isolate, a soy protein concentrate, soy grits a wheat protein, wheat gluten, wheat protein isolate, buttermilk solids, milk powder, egg protein, a canola protein, a pea protein, a potato protein, a corn protein, a sesame protein, a sunflower protein, a cottonseed protein, a copra protein, a palm kernel protein, a safflower protein, a linseed protein, a peanut protein, a lupin protein, a oat protein, oat fiber, a sugar alcohol, a calcium containing compound, a texture modifier, a tomato product, a flour, a meal, and combinations of any thereof.

8. The food composition of claim 1, further comprising:
water;
wherein the legume product, the ingredient, and the water are present in the food composition in such an amount to configure the food composition as a dip.

9-24. (canceled)

25. A food composition comprising:
whole soybean powder;
an ingredient selected from the group consisting of a soluble fiber, starch, a vegetable oil, an emulsifier and any combination thereof; and
water;
wherein the whole soybean powder, the ingredient and the water are present in the food composition in such an amount to configure the food composition as a dip.

26. The food composition of claim 25, further comprising an ingredient selected from the group consisting of a monoglyceride, a sweetener, a thickening agent, a salt, a modified starch, an organic acid, water, and combinations of any thereof.

27. The food composition of any one of claim 25, further comprising a compound selected from the group consisting of a flavoring, a seasoning, a condiment, and combinations of any thereof.

28. The food composition of claim 25, wherein 33 grams of the food composition comprises:
less than 60 calories; and
at least 3 grams of dietary fiber.

29. A food composition comprising:
an edible bean powder;
an ingredient selected from the group consisting of a soluble fiber, a starch, a vegetable oil, an emulsifier, and any combination thereof; and
water;
wherein the edible bean powder, the ingredient and the water are present in the food composition in such an amount to configure the food composition as a dip.

30. The food composition of claim 29, further comprising an ingredient selected from the group consisting of a monoglyceride, sodium stearoyl lactylate, dried buttermilk, carrageenan, an artificial sweetener, a thickening agent, a salt, a modified starch, an organic acid, water, and combinations of any thereof.

31. The food composition of claim 29, further comprising a compound selected from the group consisting of a flavoring, a seasoning, a condiment, and combinations of any thereof.

32-37. (canceled)

38. The food composition of claim 25, further comprising a compound selected from the group consisting of an interesterified soybean oil, a hydrogenated cottonseed oil, a sunflower oil, a cellulose gel, pectin, xanthan gum, sodium citrate, salt, starch, lactic acid, citric acid, dried buttermilk, non-fat dry milk, carrageenan, and combinations of any thereof.

39. The food composition of claim 29, further comprising a compound selected from the group consisting of an interesterified soybean oil, a hydrogenated cottonseed oil, a sunflower oil, a cellulose gel, pectin, xanthan gum, sodium citrate, salt, starch, lactic acid, citric acid, dried buttermilk, non-fat dry milk, carrageenan, and combinations of any thereof.

40. A container comprising the food composition of claim 1.

41. A container comprising the food composition of claim 25.

42. A container comprising the food composition of claim 29.
